(19) United States
(12) Patent Application Publication
(10) Pub. No.: US 2018/0355679 A1
(43) Pub. Date: Dec. 13, 2018

(54) Clamp Device and Method of Applying a Clamp

(71) Applicant: Completion Products Limited, Aberdeen (GB)

(72) Inventor: Mark Gruber, Aberdeen (GB)

(21) Appl. No.: 15/580,597

(22) PCT Filed: Jun. 8, 2016
(86) PCT No.: PCT/GB2016/051694

§ 371 Date: Dec. 7, 2017

(30) Foreign Application Priority Data
Jun. 9, 2015 (GB) 1510008.4

(51) Int. Cl. E21B 17/10; F16L 3/10

(52) U.S. Cl. CPC E21B 17/1035; F16B 2/065; F16L 3/1075

(57) ABSTRACT

A clamp device (1) having first and second body portions (10, 20) adapted for connection together, and having at least one fastener (50) adapted to fasten the body portions together. The clamp device has a locking member (61, 62) adapted to lock the fastener to at least one of the body portions. Typically the locking member locks the fastener to one of the body portions to create a hard joint between the fastener and the body portion, in which the fastener is tensioned to a high tension, and a soft joint between the first and second body portions, which is subjected to a lower tensions than the hard joint.

The present invention relates to a clamp device and a method of applying a clamp, particularly a clamp adapted to attach to an elongate member such as a tubular, especially an oil or gas well tubular such as a length of production tubing, although any kind of OCTG type tubular is applicable, for the retention and protection of lines extending along the elongate member, for examples, on the outer surface of the elongate member.

### BACKGROUND

Different types of oil and gas well tubulars are connected end to end in strings and are used in oil and gas wells to convey production fluids from the reservoir to the wellhead, and to convey fluids and equipment from the wellhead into the well for wellbore operations. Various external conduits are often connected to the outer surface of the tubulars, to act as power, signal and/or fluid conduits, which are often used to control downhole tools connected in the string of tubulars, or to inject chemicals from the surface into the well from time to time. The external conduits are frequently clamped onto the outer surface of the well tubular, frequently onto an inner tubular such as production tubing, which runs inside larger diameter strings of casing etc. These clamps are typically called cable protectors, although the conduits they clamp onto the tubular could include carry any kind of power, signal, fluids and could be any kind of umbilical, so are not restricted to electrical cables. Cable protectors are typically installed between the wellhead and the reservoir of an oil or gas well. The purpose of the cable protector is to support and protect power cables, instrument cables, hydraulic lines, chemical injection lines, fibre optic lines etc. (cables) as they pass from the wellhead down the well to various items of downhole equipment such as electro-submersible pumps, safety valves, downhole pressure and temperature gauges etc.

A typical cable protector clamps onto the outer surface of the production tubing and straddles the tubing coupling, which has an increased outer diameter, and axial movement of the protector relative to the coupling is restricted by internal shoulders on the protector. The protector assembly typically comprises a cast or machined body having axial slots recessed on its inner surface to accommodate and grip the cables, and at least one clamping arm which can be pivotally connected to the body at a first end and which has a fastening mechanism at a second end to connect that second end to the body. The body extends over the cables and the production tubing at the tubing joint or coupling, and the clamping arm is then swung closed and the fasteners pull the body and clamping arm together thereby clamping the protector on to the tubing. The fastener makes a soft joint between the clamping arm and the body, leaving a circumferential gap between the clamping arm and the body to ensure that the effect of tensile load generated from the bolt being torqued is that the protector will be securely clamped to the tubing. This makes the protector body less likely to rotate or move axially on the tubing once the clamp is applied.

During the installation of a completion for a well that has a subsea wellhead the completion string with the associated tools and cables extending along the outer surface is generally lowered from a floating rig down through a marine riser before it enters the wellhead at the seabed and passes down into the casing. During severe weather conditions the floating rig will move up and down and side to side. The effect of this is that the tubing is pulled in and out of the well and the protectors are subjected to repeated impacts as they pass through the various inner diameters of the wellhead. The protectors are also subjected to high frequency vibration from the tubing and repeated lateral or sideways impacts and loads from the riser as it bends with the underwater currents.

### SUMMARY

The present invention provides a clamp device having first and second body portions adapted for connection together, and having at least one fastener adapted to fasten the body portions together, wherein the clamp device has a locking member adapted to lock the fastener to at least one of the body portions.

Optionally the first and second body portions are adapted to be releasably connected together by the fastener.

Optionally the first and second body portions can comprise separate components connected together, e.g. pivotally, to allow relative movement of the two body portions when being tensioned around the item to be clamped. In some examples, the separate body portions can be connected together by other means, e.g. fasteners.

Optionally in other examples, the first and second body portions can comprise first and second (e.g. opposite) ends of a single elongate member which is adapted to be tensioned around an item to be clamped. Thus the first and second body portions can be separate or different parts of a unitary component.

Optionally the locking member restricts rotational movement of the fastener relative to the body portion.

The present invention also provides a clamp device having first and second body portions adapted for releasable connection together, and having at least one fastener to connect the body portions together, and adapted to form a hard joint between the fastener and at least one of the body portions.

Optionally one of the body portions can comprise a clamp arm adapted for releasable connection to the other body portion. Optionally more than one clamp arm can be provided.

The body portions optionally cooperate to clamp onto the outer surface of an elongate member such as an oil or gas well tubular. Optionally the body portions at least partially surround the circumference of the elongate member. Optionally the clamp device can be applied to a coupling or connection between adjacent lengths of elongate member. Optionally a clamp device can be installed over each coupling in a string of elongate members, although this is not necessary, and the clamp device could be installed on, for example, every second coupling or less, and the spacing between the clamps could be regular or irregular. Optionally clamp devices can be installed between couplings.

Optionally the locking member locks the fastener to one of the body portions to create a hard joint between the fastener and the body portion (e.g. clamp arm), in which the fastener is tensioned to a high tension. For example, the portion of the fastener locked to the body member and optionally forming the hard joint is typically tensioned to (or close to) its maximum operating tension.

According to some examples, the clamp device is adapted to form a soft joint between the first and second body portions and a hard joint between the fastener and the said one of the first and second body portions. Optionally the hard and soft joints are at least partially formed by the fastener, which can be subjected to different tensions in the hard and soft joints.

Optionally the clamp device leaves a circumferential gap in the soft joint between the body portions when the fastener is locked. Optionally in the soft joint between the first and second body portions the fastener is subjected to lower tension than in the hard joint. Thus, in certain examples, the fastener experiences different tension in different portions. In the portion of the fastener making up the hard joint, where the fastener is connected to the said one of the first and second body portions, for example, to the clamp arm, the portion of the fastener locked to the body portion is subjected to high tension, for example, at or close to the maximum tension of the fastener. However, in the portion of the fastener making up the soft joint between the first and second body portions the tension in the fastener is optionally lower than in the hard joint.

Optionally the locking member maintains tension on at least a portion of the fastener engaging the body portion. Optionally the locking member maintains a minimum tension in the fastener. Optionally the locking member maintains different tension in selected parts of the fastener. For example, the tension is maintained at a higher level in the part of the fastener adapted to be locked to the said one of the first and second body portions e.g. engaging the clamp arm, i.e. between a fixing on the fastener such as the bolt head and the locking nut on the other side of the body portion, and optionally forming the hard joint. The tension in the part of the fastener connecting the two body portions is optionally lower than the tension in the part of the fastener locked to the first and second body portions, and so optionally a soft joint is formed between the first and second body portions, while a hard joint is maintained between the fastener and the body portion to which the fastener is locked.

Optionally, the fastener is threaded, and engages a cooperating thread on one of the body portions. In one example, the fastener comprises a shaft with an external thread, which engages an internal thread in a cooperating nut which can be retained by the body. Optionally the fastener passes through a collar on the body portion to which it is locked e.g. on the clamp arm, and is rotatably mounted on the body portion (e.g. on the collar) prior to locking. Optionally the collar is compressed between a portion of the fastener on one side (for example a stop member such as a head of the fastener) and the locking device on the other side, optionally thereby optionally forming a hard joint between the fastener and the collar on the body portion.

Optionally, the locking member comprises first and second locking devices.

Optionally, the first and second locking devices interact with the fastener on opposite faces of the body portion, e.g. on opposite faces of the collar. Optionally the locking device reacts against the body portion to which the fastener is locked. Optionally the first and second locking devices exert forces on the fastener in opposite directions in the event of tensile changes in the fastener.

Optionally the locking member incorporates at least one cam device, acting to transfer rotational forces acting on the fastener (or the locking nut) into axial forces.

Optionally the locking member resists rotation of the fastener relative to the body portions, e.g. relative to the collar.

The locking member optionally comprises a locking nut, and the fastener is optionally locked to the body portion by the locking nut.

Optionally the locking member comprises at least one (optionally more than one) locking washer, and optionally at least one (optionally more than one) locking nut. A locking washer is optionally compressed by the locking nut in an axial direction of the fastener. The locking washer is optionally clamped between the collar and the head of the fastener and/or between the collar and the locking nut. The locking nut and the locking washer optionally surround the fastener, e.g. the shaft of the fastener. The locking washer is optionally compressed against the body portion. The washer can be compressed between the locking nut and the body portion (e.g. the collar) and/or optionally between a head of the fastener (e.g. a bolt head) and the body portion (e.g. the collar). At least one locking member engages the body portion and at least a component of the fastener. The locking member forms a hard joint between the fastener and at least one of the body portions. Optionally locking washers are used in pairs, and incorporate wedged surfaces on opposed inner faces that engage one another which act as cam devices, and having gripping surfaces on outer faces. The outer faces optionally grip the bolt head, lock nut or the collar of the body portion so that the outer faces move with the bolt head etc. A suitable design of locking washer is disclosed in GB2136077 which is incorporated herein by reference. The cooperating and opposed wedged surfaces of the locking washers are optionally set at the same angle in each pair, which is optionally larger than the angle of the thread on the fastener. Accordingly rotation of the fastener (e.g. the bolt head) or the locking nut engaged with the outer gripping faces of the locking washers tending to loosen the fastener applies additional transient tension to the fastener, and resists loosening.

Optionally the first and second body portions can be formed of metal for example, from cast steel, pressed steel, or from polymer material. More than two body portions can be provided, and the body portions can have one or more clamping segments. The clamping arm can also be in the form of a second body and can comprise one or more fasteners.

The invention also provides a clamp assembly comprising a well bore tubular, and a clamp device clamped to the tubular, the clamp device having first and second body portions adapted for releasable connection, and having at least one fastener to connect the body portions together, wherein the clamp device has a locking member to lock the fastener to one of the body portions when the clamp device is clamped to the tubular.

The invention also provides a method of applying a clamp, the clamp having first and second body portions adapted for releasable connection, and having at least one fastener to connect the body portions together, the method comprising locking the fastener to at least one of the body portions.

The invention also provides a method of applying a clamp, the clamp having first and second body portions adapted for releasable connection, and having at least one fastener to connect the body portions together, the method comprising connecting the fastener to at least one of the body portions with a hard joint.

Optionally the fastener is tensioned before the locking member is applied.

Optionally the clamp device is adapted for clamping lines (e.g. control lines, cables, conduits, umbilicals or the like) onto the outer surface of oil well tubulars, such as tubing, casing, liner, pipe, etc. The clamp device can incorporate axial channels adapted to accommodate and grip the lines on the outer surface of the tubular.

Optionally the locking member locks the fastener to the body portion to create a hard joint between the fastener and the body portion, e.g. the clamp arm.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. Any subject matter described in the specification can be combined with any other subject matter in the specification to form a novel combination. The invention is also capable of other and different examples and aspects, and its several details can be modified in various respects, all without departing from the spirit and scope of the present invention. Accordingly, the drawings and descriptions are to be regarded as illustrative in nature, and not as restrictive. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

All numerical values in this disclosure are understood as being modified by “about”. All singular forms of elements, or any other components described herein are understood to include plural forms thereof and vice versa. References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

### BRIEF DESCRIPTION OF DRAWINGS

In the accompanying drawings:

FIG. 1 shows a side view of a clamp device applied to a coupling between two adjacent sections of production tubing, for running into an oil or gas well;

FIG. 2 shows a section view through line 2-2 of FIG. 1;

FIG. 3 shows a side view similar to FIG. 1, on arrow A of FIG. 2;

FIG. 4 shows a detailed view of a body, clamping arm and fastener of the FIG. 1 arrangement;

FIG. 5 shows a close up view of a clamping arm of FIG. 3;

FIG. 6 shows a close up view of the fastener of FIG. 4 in a locked configuration;

FIGS. 7-10 show sequential views showing the sequence of events in connecting the FIG. 1 clamp to the tubing;

FIG. 11 shows a close up view of the fastener in FIG. 10, in the locked configuration;

FIG. 12 shows a close up view of the fastener in FIG. 9, in the unlocked configuration; and

FIG. 13 shows a close up view of the fastener in FIG. 11, in the locked configuration.

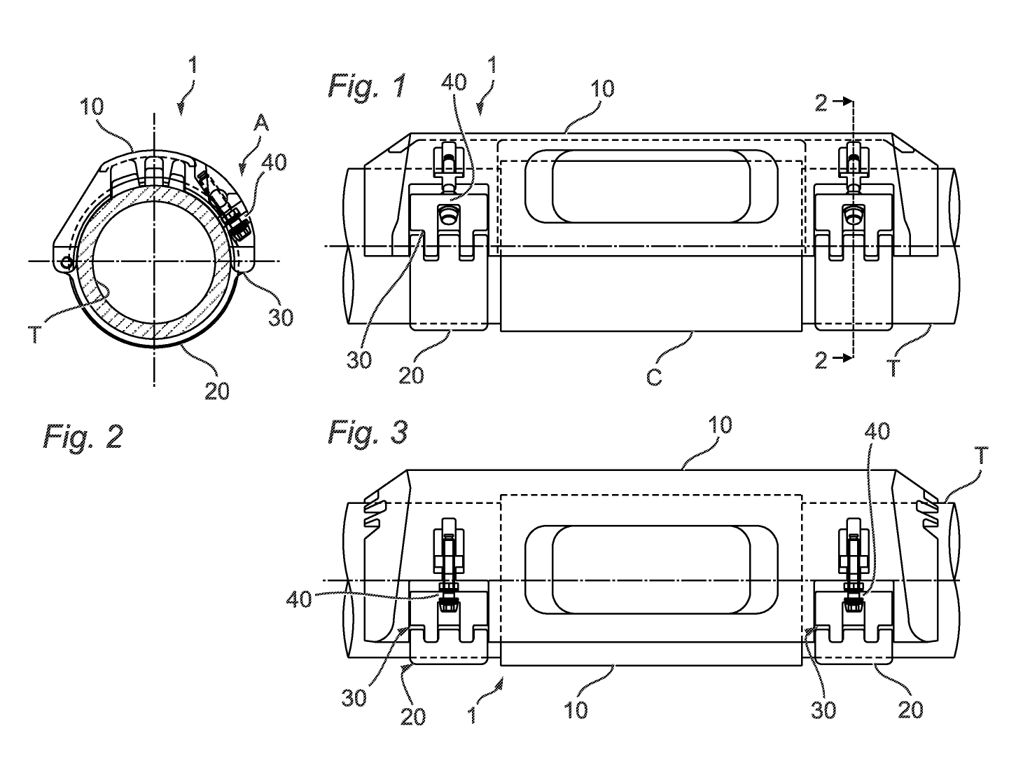

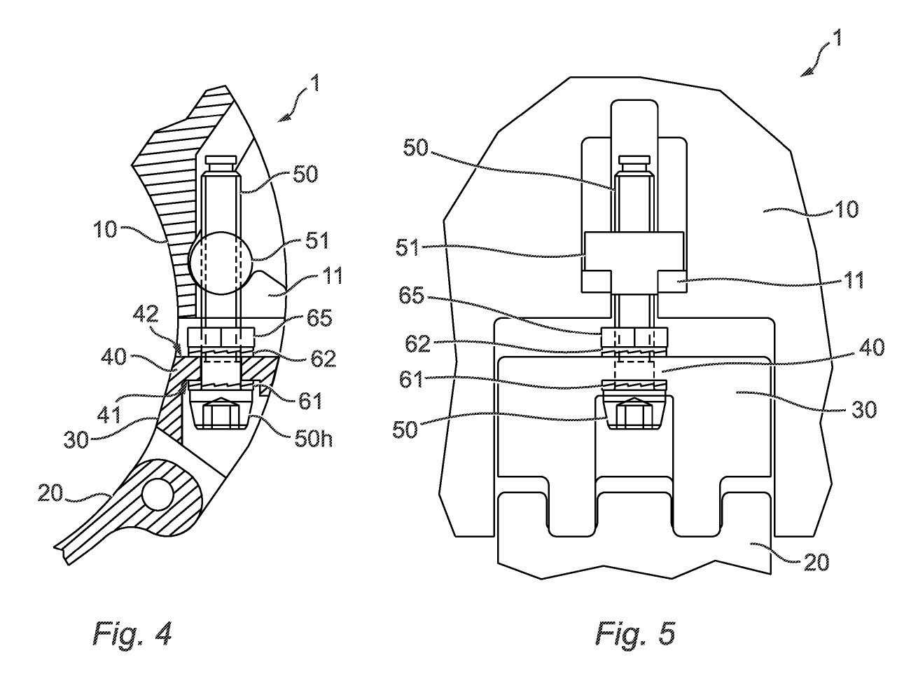

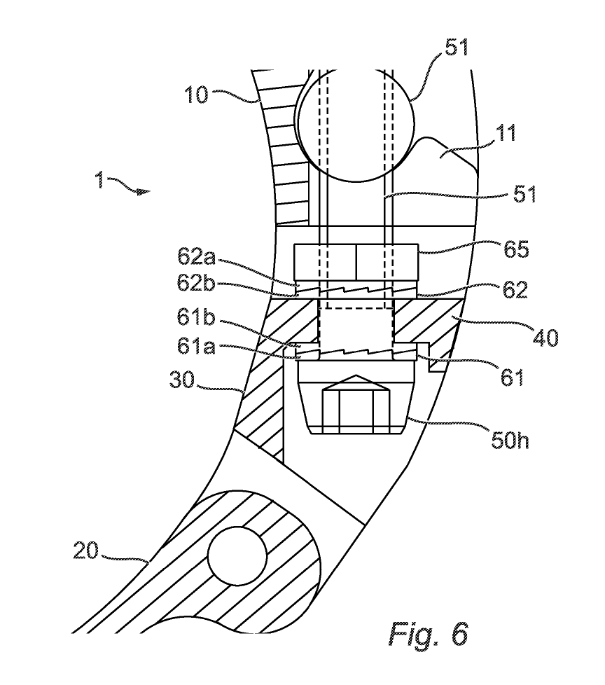

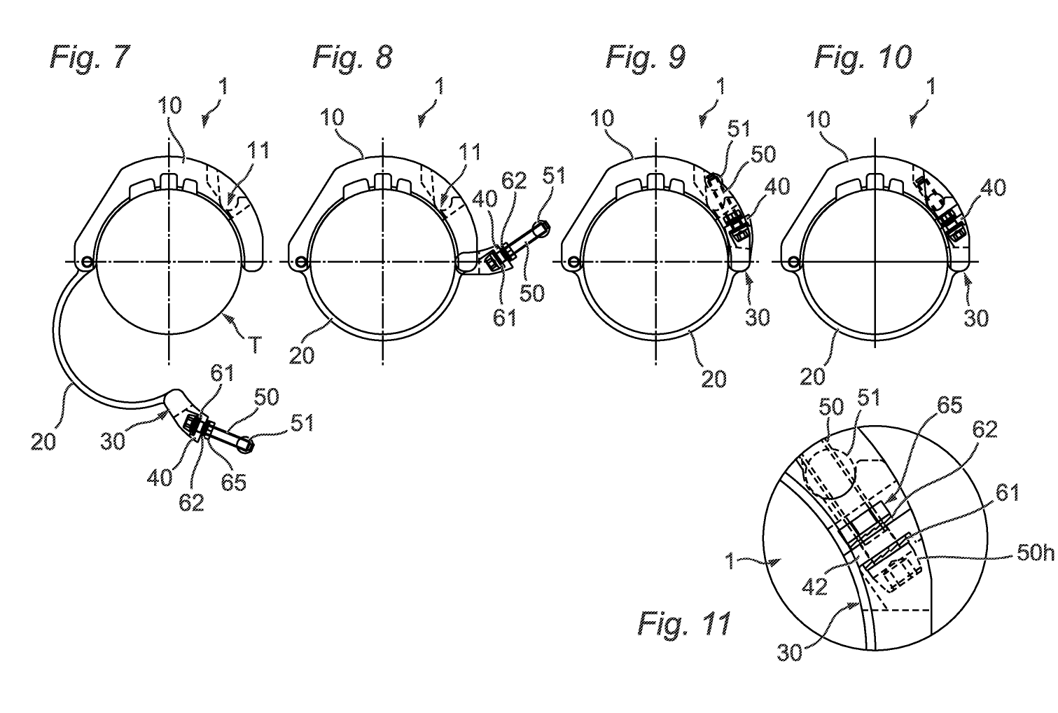

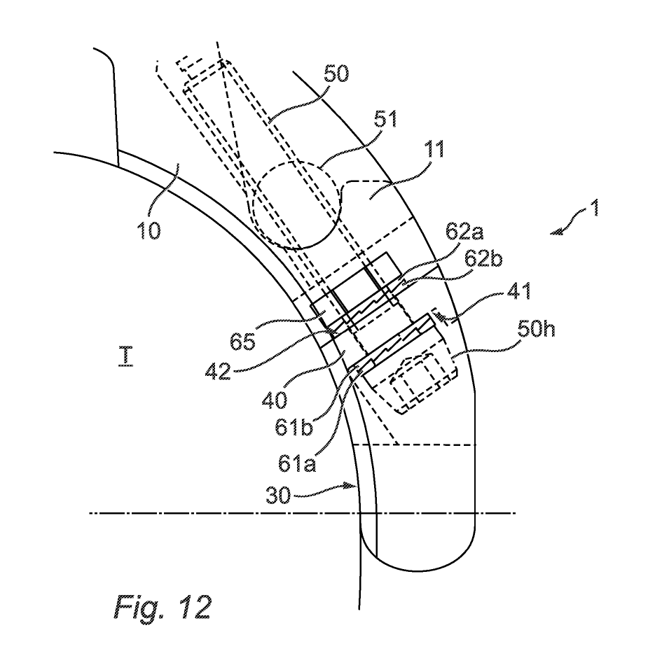

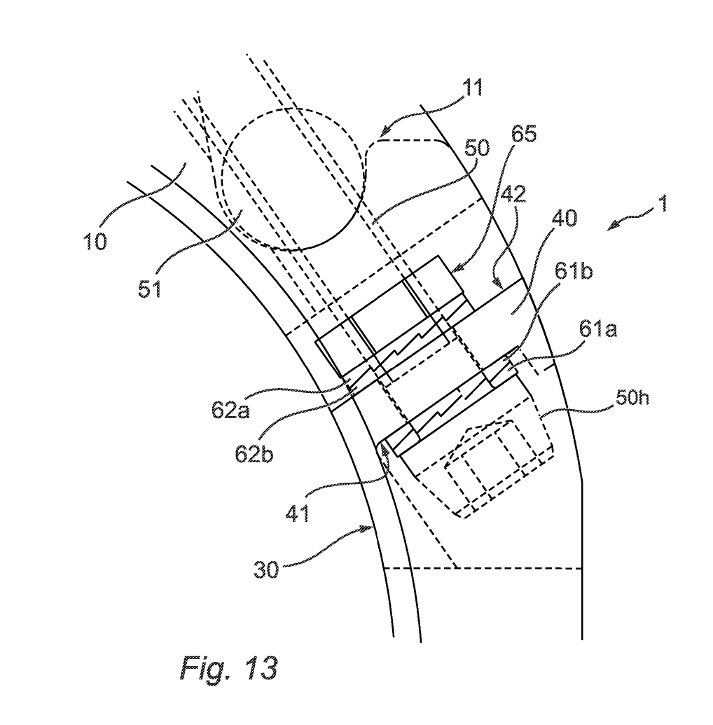

### DETAILED DESCRIPTION

A clamp device 1 for clamping a control line (or other line e.g. control lines, cables, fluid conduits, fibre optic lines, umbilicals or the like) to an elongate member such as a length of production tubing T (or casing, liner, tubing or other pipe, etc.) for use in an oil or gas well has a first body portion in the form of body 10, and a second body portion which in this example is in the form of a first clamp arm 20 optionally pivotally attached to the body portion at one end and a second clamp arm 30 optionally pivotally attached to the first clamp arm 20 at one end, and adapted for releasable connection to the body 10 at the other end. The clamp device 1 has a pair of fasteners one at each end of the body 10 in this example in the form of bolts 50 having a shaft with an external thread and cooperating with a pair of barrel nuts 51 each having a socket with an internal thread, which cooperate to apply tension to the clamp device and to connect the second clamp arm 30 to the body 10 at each axial end of the body 10 when the clamp device is applied to the tubing T, optionally on a joint or coupling C between two adjacent lengths of tubing. In the present example, the bolt 50 passes through a bore extending through a collar 40 on the second clamp arm 30, and can freely rotate within the collar 40 when unlocked. The barrel nuts 51 engage in slotted yokes 11 on the body 10 as best shown in FIG. 5, and can be released from the yokes 11 by loosening the tension on the bolts 50 until the nuts 51 move down the threaded shaft of the bolt 50 away from the bolt head 51 allowing the bolts 50 and nuts 51 to pivot freely with respect to the clamp arm 30 as best shown in FIG. 8. The fastener (e.g. the bolts) is optionally captive on the body portion (e.g. the clamp arm 30), and although it can swing around its pivot axis, the pivot axes hold them and the nuts 51 captive against separation from the clamp device 1. The body and the clamp arms can optionally be cast or can be formed from sheet material and can comprise a metal such as steel or a polymer material such as Nylon™.

When the clamp device 1 is to be applied, the clamp body 10 is placed on the outer surface of the tubing T, and any cables, conduits or other lines that are to be secured to the outer surface of the tubing T by the clamp device 1 are located within the axial slots extending along the body 10. The first and second clamp arms 20, 30 pivot around the connections so that the body 10, and arms 20, 30 circumferentially surround the tubing T. When the clamp device 1 is in place with the control lines etc. located within the slots, the bolts 50 and nuts 51 are swung around the pivot axes to engage with the yokes 11, and the bolts 50 are then tensioned by torqueing the heads of the bolts in order to draw the barrel nuts 51 into the yokes 11, and thereby apply tension to the clamp device 1 to clamp it onto the tubular T. In this example, the bolt has a fixed head 50h, but the head of the fastener could comprise a nut rotatably mounted on a threaded stud.

The clamp device 1 can of course be used on other elongate members apart from production tubing, and with other fasteners apart from bolts, and the invention disclosed is not intended to be limited by these features. Likewise, the second body portion, which in this example is shown as two arms can be provided in the form of one or more than two arms, or alternatively, the second body portion can be formed by another partial shell similar to the body 10, which can be connected to the body 10 by fasteners such as the bolts 50 and nuts 51 as described. Thus the invention can be practised in different forms, and is not intended to be limited to the particular examples shown here.

The clamp device 1 has a locking member in the form of locking washers to lock the bolt 50 to the clamp device 1 as will now be described below. In this example, the locking member on the bolt 50 comprises first and second locking devices in the form of two pairs of locking washers 61 and 62 mounted on the shaft of the bolt which interact with the bolt 50 on opposite faces of the collar 40, and which resist rotation of the bolt 50 relative to the clamp arm 30 when locked, and a locknut 65 engaging the shaft of the bolt 50 and arranged on the outer surface of the locking washers 62. The washers 61, 62 are not threaded on their inner bores, and fill the space between the fastener and the body portion, so that no gap is left between the locking member (or the head of the fastener) and the body portion when the joint is made up.

Locking washers 61 comprise a cooperating pair as likewise do washers 62, and each washer in each pair incorporates wedged surfaces on opposed inner faces that engage one another, and gripping surfaces on outer faces. The outer faces of washers 61 grips the head 50h of the bolt 50 on one side (61a) and on the other side (61b) grips one face 41 of the collar 40 opposing the head 50h of the bolt 50 leaving no unfilled space between the bolt head 50h and the collar face 41 when the locking member is applied and tensioned. The outer faces of the washers 62 grip the lock nut 65 on one side (62a) and on the other side (62b) grip the opposite face 42 of the collar 40, again leaving no gaps when the locking member is applied. A suitable design of locking washer is disclosed in GB2136077 which is incorporated herein by reference, and to which the reader is referred for additional details, which will not be repeated herein for brevity. The facing inner wedged surfaces of the locking washers 61, 62 are set at the same angle, which is larger than the angle of the thread on the bolt 50. Further, the outer faces of the washers 61a, 62a are toothed, and so grip the bolt 50, collar 40 and locknut 65, so that rotation of the bolt head 50h or the locking nut 65 engaged with the outer gripping faces of the locking washers 61a, 62a in a loosening direction (e.g. turning the bolt 50 anticlockwise or the lock nut 65 clockwise) turns the outer washers 61a, 62a in each pair relative to the inner washers 61b, 62b, which drives the wedges on the inner surfaces of the washers against each other acting as a cam and hence applying transient additional tension to the bolt 50, and resisting loosening of the bolt 50. Hence, the bolt 50 (and optionally the locking nut 51) is less reactive to vibration or impact damage, and can allow safer handing and installation of completions through marine risers in rough weather which tend to result in significant problems for clamp components.

Once the body 10 is placed on the outer surface of the tubing T with the control lines or other conduits in place in the axial slots, the clamp arms 20 and 30 are swung around their respective pivot points to circumferentially encircle the tubing T. The nuts 51 are swung into the yokes 11 and the bolts 50 are tension. In this example, the bolts 50 are M10 bolts torqued to 30 ft. lbs. The nuts 51 are held in the yokes 11 and prevented from turning.

After the bolts 50 are torqued to the recommended torque (for an M10 bolt in this example, a suitable torque would normally be 30 ft. lbs, but this can differ in other examples), the clamp device 1 is now clamped securely to the tubing T. The joint made by the fastener between the body portions is a soft joint; the tensioned fastener is reactive to tension changes in the fastener i.e. it can stretch and recover resiliently to a small extent in response to tension changes, for example, the relative movement of the two body portions, and is not tensioned to its limit in the soft joint. Also, the soft joint has a gap between the body portions connected by the fastener. Thus the soft joint permits relative movement between the body portions in response to changes in tension in the fastener, for example, damage to the tubing T which affects its circumferential shape, causing a potential reduction in the cross sectional area gripped by the clamp device, allowing the fastener connected between the body portions to stretch and recover resiliently to a small degree in reaction to changes in tension acting on the fastener, and maintains at least some tensile force on the body portions to draw them together around the tubing T even in the event of changes to the tubing T. Thus the soft joint maintains its grip on the tubing T even when the clamp device or the tubing T is subjected to impact damage.

After the bolt 50 has been torqued to the correct value to form the soft joint and clamp the clamp device onto the tubing T, the locking member is actuated. In this step, lock nut 65 is rotated anticlockwise to move it axially along the shaft of the bolt 50 towards the head 50h of the bolt 50 and thereby engage and compress the locking washers 62a, 62b between the lock nut 65 and the surface 42 of the collar 40. The lock nut 65 is torqued to the required torque which in this case would be approximately 15 ft. lbs. The bolt 50 is now locked in position. The collar 40 is now compressed between the head 50h of the bolt 50 and the lock nut 65, with the locking washers 61, 62 filling the gaps in the joint. The bolt 50 is locked against rotation relative to the collar 40 by means of the locking washers 61a, 61b compressed between the head 50h of the bolt 50 and the face 41 of the collar 40 on the clamp arm 30. The fastener now forms a hard joint with the collar 40 on the second body member, and is relatively unreactive to tensile changes in the shaft of the bolt 50 as a result of the locking washers 61, 62, and does not stretch and recover resiliently to the same degree as the soft joint in response to changes in tension. The hard joint locking the fastener to the body portion is also at a higher tension than the soft joint, as the portion of the fastener forming the hard joint is subjected to the tension of the nut 51 on the shaft plus the tension applied by the locknut 65 only to the hard joint. Further, the hard joint is less likely than the soft joint to lose tension as a result of deformation of the body because there are no spaces between the material clamped between the fastener and the locking member to permit deformation. The bolt 50 and lock nut 65 engage firmly on opposite sides of the collar 40 and apply a compressive load to the collar 40 substantially equal to the tensile load of the bolt 50. The hard joint keeps the fastener locked onto the body even if the tension in the fastener forming the soft joint between the body portions is reduced due to the gap between the body portions closing under intermittent impact and vibration.

As the bolt 50 is initially tightened the gripping teeth on the outer surfaces of the washers 61 dig into the relatively soft material of the bolt head 50h and the clamp arm 30. After initial tensioning, any anti-clockwise (loosening) rotation of the bolt 50 relative to the nut 51 results in rotational torque being transferred to the bolt side washer 61a which grips the bolt head 50h. However, washer 61a rotates with the bolt 50 while washer 61b adjacent to the collar 40 remains stationary, as it grips the surface 41 of the static collar 40. The wedges on the inner faces of the washers 61 force the washers 61 apart in a direction along the axis of the bolt shaft at a faster rate than any axial movement of the bolt 50 because the angle of the wedges on the inner faces of the washers 61a, b is greater than the angle of the thread of the bolt 50. Hence, upon any action tending to loosen the bolt 50 and nut 51, the effect of the washers is to transiently increase the tensile load acting on the bolt 50 instead of decreasing it. The force required to loosen the bolt 50 is thus increased until the inner faces of the washers 61 slip over their highest point.

The purpose of the lock nut 65 being advanced anticlockwise to apply force back towards the head 50h of the bolt 50 is to maintain tensile load in the shaft of the bolt 50 between the bolt head 50h and the lock nut 65. Washers 62 compressed between the lock nut 65 and the collar 40 behave in the same way as washers 61. Thus as the lock nut 65 is initially tightened the first washer 62a rotates together with the lock nut 65 as the gripping teeth on the outer surfaces of the washers 62 dig into the relatively soft material of the lock nut 65 and the collar 40. Any clockwise rotation of the lock nut 65 after initial tightening tending to back the nut 65 away from the bolt head 50h results in rotational torque being transferred to the lock nut side washer 62a which grips the lock nut 65, so that washer 62a begins to rotate while washer 62b adjacent to the collar 40 remains stationary, as it grips the static surface 42 of the collar 40. Hence, upon any action tending to loosen the lock nut 65, the effect of the washers 62 is to transiently increase the tensile load acting on the shaft of the bolt 50 instead of decreasing it.

Maintaining tension in this section of the shaft of the bolt 50 above a minimum level reduces the effects of vibration and deformation of the body 10 or deformation of any part of the clamp device 1 because the bolt 50 forms a hard joint with the collar 40, which is resistant to changes in tensile forces (e.g. resistant to tension and compression). There are no forces that the clamp device 1 will be subjected to that will cause the hard joint formed by the bolt and locking devices 61, 62 to compress more than it is being compressed by the bolt and lock nut already, and therefore the tensile load in the bolt 50 can be maintained until is it manually loosened. In this example, the tension in the shaft of the fastener engaging the body portion (e.g. here the collar 40) is maintained at a higher level than the tension in the rest of the fastener, for example, between the lock nut 65 and the nut 51 which forms a soft joint between the body portions (e.g. between the clamp arm 20 and the body 10) while a hard joint is maintained between the fastener and the body portion formed by the clamp arm 20 in this instance. Thus the clamp 1 benefits from a soft joint applying the correct tension to the body 10, and a hard joint applying higher tension to the fixing as it engages the body portion, which in this example resists loosening of the bolt 50 from the arm 20.

In a modification of this example, the locking washers 61 could be omitted, leaving only the locking washers 62 compressed between the locking nut 51 and the body portion.

Examples of the invention can be used on clamps installed on the outer surface of tubing such as production tubing deployed in a marine riser, and can permit more secure retention of the fastener on the clamp, and reduced susceptibility for vibration and contact damage tending to loosen the clamp. Hence, examples of the invention can reduce the risk of damage to the cables and to the devices they power and control in lower regions of the well, and since the clamps are better secured to the tubing, the risks of damage to the riser from dropped clamps are also reduced, which therefore improves the environmental containment of the entire system.

Examples of the invention have been described with reference to cable protectors, but other types of clamp devices, especially those installed on tubing being run in oil and gas wells, could be used. The bolt and nut arrangements could be reversed and could have bolts captive on the collars or on the bodies. The bolt could also comprise an eyebolt that swivels with a nut instead of a bolt head 50h or could comprise another design of fastener. The clamp device could have threaded holes (e.g. in the body) for the bolts to engage instead of nuts. The nut can be any shape or form, e.g. barrel shaped, toggle etc. It can be cast or machined.

1. A clamp device adapted for clamping a line to a wellbore tubular for deployment in an oil or gas well, the clamp device having a body portion and a clamp arm adapted for releasable connection together, and having at least one fastener adapted to fasten the clamp arm to the body portion, wherein the clamp device has a locking member adapted to lock the fastener to one of the body portion and the clamp arm.

2-7. (canceled)

8. A clamp device as claimed in claim 1, wherein the fastener is threaded, and is adapted to engage a cooperating thread adapted to be retained on the other of the body portion and the clamp arm.

9-11. (canceled)

12. A clamp device as claimed in claim 1, wherein the locking member is adapted to increase tensile forces in the fastener in the event of loosening of the fastener from the said one of the body portion and the clamp arm.

13. A clamp device as claimed in claim 1 wherein the locking member comprises first and second locking devices.

14. A clamp device as claimed in claim 13, wherein the first and second locking devices engage the fastener on opposite faces of the said one of the body portion and the clamp arm.

15. A clamp device as claimed in claim 13, wherein the first and second locking devices are adapted to exert forces on the fastener in opposite directions in the event of tensile changes acting on the fastener.

16. A clamp device as claimed in claim 1, wherein the locking member incorporates at least one cam device, adapted to transform rotational forces acting on the locking member into axial forces that are applied to the fastener.

17. (canceled)

18. A clamp device as claimed in claim 1, wherein the locking member comprises at least one locking washer and at least one locking nut, wherein the fastener passes through a collar on the at least one of the body portion and the clamp arm, and wherein the collar is compressed between a head of the fastener and the at least one locking nut.

19. (canceled)

20. A clamp device as claimed in claim 1, wherein the or each locking member comprises a pair of locking washers, wherein each locking washer in each pair has inner and outer surfaces, wherein in each pair the inner surface of one washer engages the inner surface of the other washer, and wherein the inner surfaces incorporate at least one cam device.

21-23. (canceled)

24. A clamp device as claimed in claim 20, wherein the locking member has two outer faces each adapted to grip the fastener or the collar so that the outer faces move with the fastener or the body portion.

25. A clamp device as claimed in claim 1, wherein the locking member comprises a pair of locking washers each with an inner and an outer face, and each inner face incorporating a cam device having opposed wedged formations set at the same angle on each inner surface, wherein the angle of the wedged formations with respect to the inner surface is larger than the angle of a thread on the fastener.

26. A clamp device as claimed in claim 1, wherein relative rotation of the fastener and the locking member tending to loosen the fastener from the at least one of the body portion and the clamp arm applies additional transient tension to the fastener, and resists loosening of the fastener from the at least one of the body portion and the clamp arm.

27. A clamp device as claimed in claim 1, wherein the locking member comprises at least one locking nut and at least one locking washer, and wherein the fastener is locked to the said one of the first and second body portions by the locking nut which compresses the at least one locking washer against the said one of the body portion and the clamp arm.

28-29. (canceled)

30. A clamp device as claimed in claim 1 wherein the locking device is adapted to maintain a different tension in the portion of the fastener locked to the said one of the body portion and the clamp arm than in the portion of the fastener connecting the body portion and the clamp arm.

31. A clamp device as claimed in claim 29, wherein the tension in the portion of the fastener locked to the said one of the body portion and the clamp arm is higher than in the portion of the fastener connecting the body portion and the clamp arm.

32. A clamp device as claimed in claim 1, wherein the clamp device is adapted to form a soft joint between the body portion and the clamp arm and a hard joint between the fastener and the said one of the body portion and the clamp arm.

33. A clamp device as claimed in claim 1 wherein the portion of the fastener locked to the said one of the body portion and the clamp arm is less reactive to tension changes in the fastener than the portion of the fastener connecting the body portion and the clamp arm.

34-37. (canceled)

38. A method of clamping a line to a wellbore tubular for deployment in an oil or gas well, the method comprising applying a clamp to the wellbore tubular and clamping the line to the wellbore tubular with the clamp , the clamp having a body portion and a clamp arm adapted for releasable connection, and having at least one fastener to connect the body portion and the clamp arm together, the method comprising connecting the body portion and the clamp arm by the fastener, and locking the fastener to one of the body portion and the clamp arm.

39. A method as claimed in claim 38, including forming a soft joint between the body portion and the clamp arm and forming a hard joint between the fastener and the said one of the body portion and the clamp arm.

40-41. (canceled)

42. A method as claimed in claim 38, including maintaining a higher tension in the portion of the fastener locked to the said one of the body portion and the clamp arm than in the portion of the fastener connecting the body portion and the clamp arm.

43. A method as claimed in claim 38, including passing a shaft of the fastener through a collar on the said one of the body portion and the clamp arm such that a head of the fastener engages on one side of the collar, and engaging the locking member on the shaft on an opposite side of the collar, and tightening the locking member to apply a compressive load to the collar.

44. A method as claimed in claim 43, including maintaining tension in the shaft of the fastener between the head of the fastener and the locking member.

45. A method as claimed in claim 38, including tensioning the fastener between the body portion and the clamp arm before actuating the locking device to lock the fastener said one of the body portion and the clamp arm.

46-49. (canceled)

50. A method as claimed in claim 38, including increasing tensile forces in the fastener in the event of loosening of the fastener.

51. A method as claimed in claim 38, wherein the locking member comprises first and second locking devices, and wherein the method includes engaging the fastener on opposite faces of the body portion with the said first and second locking devices, and exerting forces on the fastener in opposite directions in the event of tensile changes acting on the fastener.

52-53. (canceled)

54. A method as claimed in claim 38, including transforming rotational forces acting on the locking device into axial forces that are applied to the fastener.

55. (canceled)

56. A method as claimed in claim 38, including rotationally locking an outer face of the locking device to the fastener or the said one of the body portion and the clamp arm so that the outer face moves with the fastener or the said one of the body portion and the clamp arm.

57. A method as claimed in claim 38, including applying additional transient tension to the fastener upon rotation of the locking member.

58-59. (canceled)

60. A clamp device having a body portion and a clamp arm adapted for releasable connection together, and having at least one fastener adapted to fasten the clamp arm to the body portion, wherein the clamp device has a locking member adapted to lock the fastener to one of the body portion and the clamp arm, wherein the locking member comprises at least one locking washer and at least one locking nut, and wherein said at least one locking washer incorporates at least one cam device, and wherein relative rotation of the fastener and the locking nut tending to loosen the fastener from the at least one of the body portion and the clamp arm applies additional transient tension to the fastener, and resists loosening of the fastener from the at least one of the body portion and the clamp arm.
